(19) United States
(12) Patent Application Publication
(10) Pub. No.: US 2017/0374187 A1
(43) Pub. Date: Dec. 28, 2017

(54) User Input Peripheral

(71) Applicant: Microsoft Technology Licensing, LLC, Redmond, WA (US)

(72) Inventors: Malek Mohamad Nafez Chalabi, Seattle, WA (US); Vikram Khandpur, Kirkland, WA (US); Eliana Miriam Feigelstock, Seattle, WA (US); Gary T. McCoy, Oakland, CA (US)

(73) Assignee: Microsoft Technology Licensing, LLC, Redmond, WA (US)

(21) Appl. No.: 15/331,851

(22) Filed: Oct. 22, 2016

Related U.S. Application Data
(60) Provisional application No. 62/353,978, filed on Jun. 23, 2016.

(51) Int. Cl. H04M 1/725; H04M 1/60

(52) U.S. Cl. CPC H04M 1/72527; H04M 1/72525; H04M 1/6041; H04M 2250/22

(57) ABSTRACT

A peripheral device for use with a user terminal, the peripheral device comprising: a non-graphical actuator operable to be actuated by a user; an interface for connecting to the user terminal; and control logic for interfacing with the user terminal in order to control a communication client application running on the user terminal, and to thereby control a voice or video call that is conducted over a packet-based network from the user terminal using the communication client application. The control logic is configured such that the control of the call comprises performing a function in relation to the call in response to actuation of said hardware actuator by the user, and furthermore that the function of the actuation of the actuator is dependent on a current status of the call.

### RELATED APPLICATIONS

This application claims priority under 35 U.S.C. Section 119(e) to U.S. Provisional Patent Application No. 62/353,978, filed Jun. 23, 2016, and titled “User Input Peripheral”, the entire disclosure of which is hereby incorporated by reference herein.

### BACKGROUND

One existing type of peripheral for use with a mobile phone is a docking station which acts as a speaker phone when the phone is docked in the docking station. This may operate in conjunction with the native dialler of the phone (e.g. a cellular dialler) or a separate application such as a VoIP application. Either way, when the phone is docked the audio to be transmitted from the near-end user to the far end-user(s) is captured by a microphone in the docking station instead of the phone's internal microphone, and transferred from that microphone though the docking connection to the phone, then on to the far-end user terminal(s). And/or, the audio received from the far-end user terminal(s) is not played out through the phone's internal speaker, but rather is transferred from the phone to the docking station via the docking connection and played out through a speaker in the docking station. The docking station usually also supplies power to the phone during the call and charges its battery. The user can answer and control the call in the normal way by navigating through the graphical user interface presented on the display screen of the phone (nowadays typically a touchscreen).

Another type of peripheral is a hands-free headset or earpiece which pairs with a phone via a wired or more often wireless connection, e.g. a Bluetooth connection. In this case, when the phone is so paired, the audio to be transmitted from the near-end user to the far end-user(s) is captured by a microphone in the headset or earpiece instead of the phone's internal microphone, and transferred from that microphone though the pairing connection to the phone, then on to the far-end user terminal(s). And/or, the audio received from the far-end user terminal(s) is not played out through the phone's internal speaker, but rather is transferred from the phone to the headset or earpiece via the pairing connection and played out through a personal speaker in the headset or earpiece. The headset or earpiece often also comprises a set of dedicated mechanical buttons for controlling the call via the pairing connection, with a different respective dedicated function mapped to each button—such as a volume up button for increasing the volume of the playout of the received audio, a volume down button for decreasing the volume, an answer button for answering the call, a hang-up button for terminating the call, and/or a mute button for muting the transmitted audio of the call.

### SUMMARY

It is identified herein that existing peripherals are awkward for a user to use, particularly in terms of the mechanism used to control a call conducted through a user terminal docked or paired (or such like) with the peripheral, e.g. to answer an incoming call, mute the call etc. For instance, in the case of an existing docking station, it is fiddly for the user to navigate through the various on-screen controls of graphical user interface of the voice or video calling application (e.g. a VoIP application) running on the phone. It also somewhat defeats the point of the docking station—one reason for using a docking station is so the user does not have to hold the phone in his or her hand throughout, say, a long call (e.g. of the order of one hour), but with current docking stations the user still has to manually handle the phone in order to control the call. On the other hand, with a headset or earpiece, this can become cluttered with buttons, with a one-to-one mapping between buttons and respective functions (i.e. each button having a single dedicated function, e.g. volume up, volume down, answer, hang up, mute, etc.). Also there may be limited surface area on the exterior housing of the headset or earpiece, so the buttons may have to be arranged in a cramped manner and/or be made quite small, so again quite awkward to operate.

It would be desirable to provide a peripheral with a more elegant mechanism for controlling multiple aspects of a call, without requiring the user to navigate through a fiddly graphical user interface, and without cluttering the peripheral with many buttons or controls each for a different function.

According to one aspect disclosed herein, there is provided a peripheral device for use with a user terminal (e.g. phone, tablet or laptop), wherein the peripheral device comprises: a non-graphical actuator operable to be actuated by a user; an interface for connecting to the user terminal; and control logic (e.g. embedded firmware) for interfacing with the user terminal via said interface, in order to control a communication client application (e.g. a VoIP client) running on the user terminal, and to thereby control a voice or video call (e.g. a VoIP call) that is conducted over a packet-based network (e.g. the Internet) from the user terminal using the communication client application. Particularly, the control logic is configured such that said control of the call comprises performing a function in relation to the call in response to actuation of said hardware actuator by the user, and the control logic is further configured such that the function of the actuation of said actuator is dependent on a current status of the call.

Thus there is provided a multi-modal, context-sensitive hardware peripheral for controlling a call—i.e. whose function adapts to the current context in which it is actuated. For instance, in embodiments the function of the actuation of said actuator may be to answer call when the status is incoming, but the function of said actuation of the actuator becomes a second, different function when status of the call is ongoing (e.g. to mute the transmitted audio of the call).

As another example, the call may be scheduled to form part of an online meeting scheduled via a meeting invite; and the control logic may be configured such that, at a present time, the function of said actuation of the actuator is to join the meeting via said call on condition that the user has not yet joined the call and the present time is within a predetermined time window relative to the scheduled meeting, but otherwise the function of said actuation of the actuator takes on at least one second, different function.

The actuator itself is a simple hardware button or the like (and in embodiments may even be the only user input means on the whole peripheral). For instance, in embodiments said actuator may take the form of a mechanical button (e.g. a mechanical push button), or a touch sensor other than a touchscreen (e.g. a capacitive touch sensor), or a motion sensor (comprising one or more motion sensor elements, e.g. one or more accelerometers, gyroscopes and/or tilt switches). The invention therefore advantageously provides the user with a simple-to-use tangible user interface through which he or she can interact with the call in an intuitive and unencumbered fashion.

Note: “non-graphical” herein does not exclude that the actuator could have text or a picture physically printed, painted, decaled or such like on a physical surface of the actuator (e.g. the top surface of a button). Rather, by non-graphical actuator, it is meant that the actuator is an actuator other than an on-screen control of a graphical user interface (GUI), i.e. non graphical in the sense of computer graphics. That is, the actuator does not comprise a graphical element on any display screen of the peripheral. In embodiments, the peripheral does not comprise any display screen at all, thereby providing the user with a simple-to-use, uncomplicated control for interacting with a call.

The peripheral device itself may take a number of possible forms. For instance, in embodiments the peripheral may device comprises a speaker and/or microphone, arranged to enable received audio of the call to be played out to the user via said speaker and/or transmitted audio of the call to be captured from the user via said microphone. In embodiments the peripheral device may take the form of a docking station, headset, or earpiece. As another example the peripheral may take the form of stand-alone button unit with no user output means and no other user input means than said single hardware actuator, e.g. a disc shaped unit about the size of coin. In some embodiments this may have an adhesive or magnetic layer on one surface for affixing to the peripheral. E.g. in one possible embodiment the peripheral device may take the form of a fridge magnet with a magnetic layer for affixing magnetically to the fridge. Note also that the term “button” herein does not alone limit to a mechanical button. E.g. the button could be a mechanical button or a touch sensor element such as a capacitive touch sensor (other than a touchscreen).

The user terminal may also take a variety of forms, e.g. a smartphone, tablet, laptop or desktop computer, or even a smart household appliance such as a fridge. E.g. in the case where the peripheral takes the form of a fridge magnet, the user terminal may be a smart fridge (a fridge with embedded processing capabilities).

In embodiments the control logic is configured to enable the user to answer the call by said actuation of said hardware actuator without having to navigate through any graphical user interface on the user terminal. In some particular embodiments the control logic may be configured to download the communication client application to the user terminal if not installed upon the actuation of said actuator to answer the call.

In embodiments the control logic may comprise embedded software (“firmware”) and an embedded processor (comprising one or more processing units) arranged to run the embedded software. In embodiments the software is arranged to run on an embedded operating system having no presentation layer. Preferably the one or more embedded processors are arranged only to run said embedded software and no other application (i.e. the sole purpose of the peripheral device the control of the call and possibly the speaker-phone functionality).

Alternatively, the control logic may be implemented in dedicated hardware circuitry.

In embodiments the user terminal has a display screen and a user operating system having a presentation layer for rendering a graphical user interface of the communication client application on said display screen. In embodiments the communication client application is an application other than the native dialler of the operating system on the user terminal.

In embodiments the control logic may be configured to control said function by invoking a URI that links to the function within the communication client application run on or accessed through the user terminal. E.g. the URI may take the form of a mobile deep link.

According to another aspect disclosed herein, there is provided a method comprising: connecting a peripheral device to a user terminal, in order to enable the peripheral device to control a communication client application running on the user terminal, and to thereby control a voice or video call conducted from the user terminal using the client application; the user actuating a non-graphical actuator on the peripheral device; and in response to said actuation of the hardware actuator by the user, the peripheral device to performing a function in relation to the call via said connection, wherein the function of said actuation of the actuator is made dependent on a current status of the call. In embodiments, the method may further comprise operations in accordance with any of the device or system features disclosed herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put in effect, reference is made by way of example to the accompanying drawings in which:

FIG. 1 is a schematic block diagram of a communication system,

FIG. 2 shows an example design of a docking station,

FIG. 3 shows a user terminal docked with a docking station,

FIG. 4 shows a user terminal docking with a docking station,

FIG. 5 shows a user pressing a button of a docking station to answer an incoming call,

FIG. 6 gives a schematic side and top view diagrams of an example docking station,

FIG. 7 shows an example of a peripheral connecting to a laptop,

FIG. 8 shows an example of a docking station connected to a laptop,

FIG. 9 schematically illustrates a peripheral in the form of a stand-alone button unit, and

FIG. 10 schematically illustrates a peripheral in the form of a headset.

### DETAILED DESCRIPTION OF EMBODIMENTS

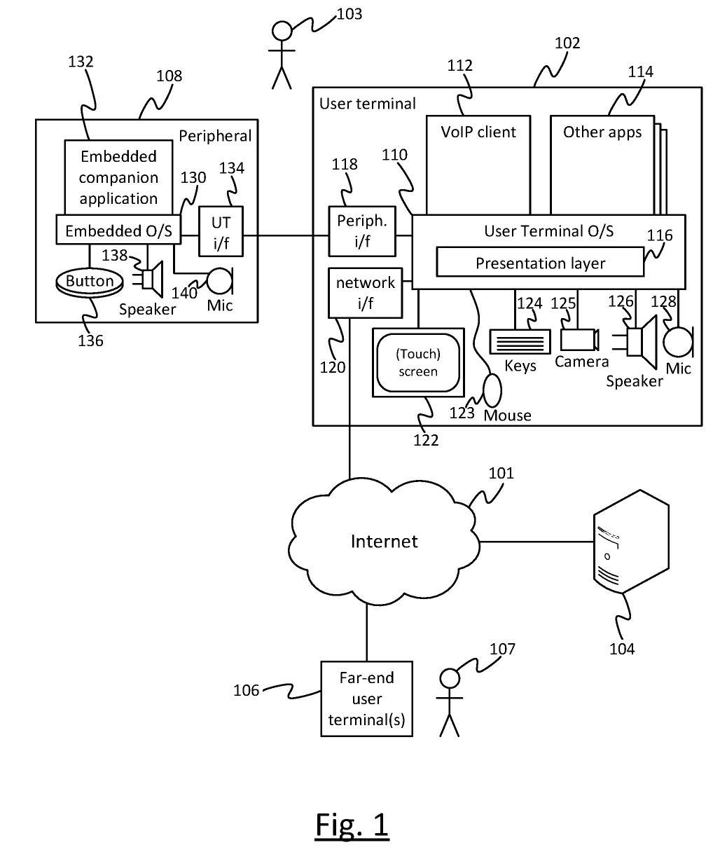

FIG. 1 illustrates and example communication system in accordance with embodiments disclosed herein. The system comprises a user terminal 102 such as a mobile phone, tablet, laptop computer or desktop computer; and a peripheral device 108 configured to connect to the user terminal 102. As will be discussed in more detail later, the peripheral 108 may take any of a variety of forms such as a docking station, headset, earpiece or dedicated button unit. The peripheral device 108 may also be referred to as a hardware accessory in that, while it may in embodiments run embedded firmware, it is a relatively simple device with a dedicated purpose and only a single or a small number of user input controls (e.g. no more than the buttons) and preferably no screen (though in embodiments it is not excluded that the peripheral 108 could have a small screen for some simple or dedicated purpose).

The user terminal 102 comprises an operating system 110, a communication client application 112, and one or more other applications 114 (e.g. in embodiments over one hundred applications, or “apps”, and even up to hundred to three hundred applications or more). The operating system 110, communication client 112 and other application(s) 114 are stored on a storage means of the user terminal 102 and arranged to be run (either executed or interpreted) on a processor of the user terminal 102, and to thereby perform the various operations attributed to them herein. The storage on which the operating system 110, communication client application 112 and other application(s) 114 are stored may comprise any one or more storage media implemented in one or more memory units. E.g. the storage means may comprise an electronic storage medium such as an EEPROM (or “flash” memory) and/or a magnetic storage medium such as a hard disk. Note also that the term “processor” as used herein does not exclude that the processor may comprise multiple processing units. The communication client application 112 and other application(s) 114 are each separate applications from one another, individual applications at least in that they are scheduled independently by the operating system 110, and/or can be launched, run and closed independently of one another.

The user terminal 102 also comprises one or more input devices for outputting information to the user 103 and one or more output devices for receiving information from the user 103 (which may be referred to collectively as i/o devices). These include one or more media output devices for outputting audio and visual information from the applications 112, 114 to the user 103, i.e. at least one speaker 126 and a screen 122, respectively. The i/o devices also include one or more media input devices for receiving audio and optionally video information from the user 103, i.e. as a microphone 128 and optionally a camera 125. Furthermore, the i/o devices comprise one or more user input devices enabling the applications 112, 114 to receive user selections from the user 103, such as a mouse or trackpad 123, a set of keys 124 (e.g. a keyboard or keypad), and/or a touchscreen 122 (the screen 122 may or may not be a touchscreen capable of both outputting visual information and receiving inputs form the user 103). The operating system 110 running on the user terminal 102 is an end-user operating system, i.e. designed for user terminals to provide an interface to the end user 103, to present information from applications 112, 114 to a user 103 through a graphical user interface presented on a screen 122, and to receive back inputs to the applications 112, 114 from the user 103 through one or more user input devices 122, 123, 124, 125, 128. As such the user operating system 110 comprises a presentation layer 116. The presentation layer 116 is the layer disposed between the application layer 112, 114 and lower layers (not shown), which formats data from the lower layers to be presented to the application layer 112, 114, and formats data from the application layer 112, 114 to be presented to the lower layers. This includes responsibility for painting graphical user interface on the screen, and receiving inputs from the user selections from the user input devices 122, 124 in relation to the graphical user interface.

Note that each of the i/o devices 122, 123, 124, 125, 126, 128 may be internal or external to the main housing in which the processor running the applications 112, 114 is housed, e.g. as follows. In embodiments the screen 122 may be an integral screen of a smartphone, tablet or laptop or an external screen of a desktop computer. The set of keys 124 may be an integral key set of a smartphone or tablet, an integral keyboard of a laptop or an external keyboard of a desktop computer. The (at least one) speaker 126 may be an internal or external speaker of a smartphone, tablet or laptop, or an external speaker of a desktop computer. The microphone 128 may be an internal or external microphone or a smartphone, tablet or laptop, or an external microphone of a desktop computer. And/or, the camera 125 may be an internal cameral of a smartphone, tablet or laptop, or an external camera connected to a laptop or desktop computer. If used, a mouse 123 is an external device, but this could instead be an integral trackpad or tracker ball of, say, a laptop computer.

The user terminal 102 further comprises a network interface 120 and a peripheral interface 118.

The network interface 120 enables the user terminal 102 to connect to a packet-based network 101 comprising one or more constituent networks. E.g. in embodiments the network 101 may comprises a wide area internetwork such as that commonly referred to as the Internet. Alternatively, or additionally, the network 101 may comprise a wireless local area network (WLAN), a wired or wireless private intranet (such as within a company or an academic or state institution), and/or the data channel of a mobile cellular network. To connect to such a network, the network interface 120 may comprise any of a variety of possible wired or wireless means as will be familiar to a person skilled in the art. For example, if the network 101 comprises the Internet, the network interface 120 may comprise a wired modem configured to connect to the Internet via a wired connection such as a PSTN phone socket or cable or fibre line, or via an Ethernet connection and a local wired network. Or alternatively the network interface 120 may comprise a wireless interface for connecting to the Internet via a wireless access point or wireless router and a local (short-range) wireless access technology such as Wi-Fi), or a mobile cellular interface for connecting to the Internet via a mobile cellular network.

The connection to the network 101 via the network interface 120 allows applications 112, 114 running on the user terminal 102 to conduct communications over the network. This includes enabling the communication client application 112 to conduct a voice or video call with another instance of the client application running on a remote user terminal 106, being used by a remote user 107. As a matter of terminology the user terminal 102 from the perspective of which a given communication scenario is being described may be referred to as the near-end terminal, whilst the other, remote user terminal 106 with which the near-end terminal 102 is communicating may be referred to as the far-end terminal (and similarly for the near-end user 103 and far-end user 107 respectively). Not also that the call could in fact be a conference call conducted with multiple remote user terminals and their respective users. By way of illustration the following will be described in terms of a given remote-user terminal 106, but it will be appreciated that the same teachings can be readily extended to multiple remote user terminals in a similar manner.

The communication client 112 on the near-end user terminal 102 is configured so as, when run on the near-end user terminal 102, to receive audio data from the microphone 128 and optionally also video data from the camera 125 and to send this data over the network 101, via the network interface 120, to be played out at the far-end terminal as part of a call conducted between the near-end user 103 and far-end user 107. Further, the communication client 112 is configured so as when run on the user terminal 102 to receive via the network interface audio and optionally video data from the client on the far-end terminal 106 to be played out through the speaker 126 and screen 122, respectively, on the near-end terminal 102.

In embodiments the communication client 112 is a VoIP client configured to conducting the call in the form of a VoIP call (which may also comprise a video element). The VoIP client may optionally also provide additional functionality such as instant messaging (IM). In some embodiments the audio and/or video content of the call may be routed via a server 104 of a provider of a communication service used to conduct the call (where a server as referred to herein may comprise one or more physical server units at one or more geographical sites). Alternatively, some or all of the audio and/or video content of the call may be sent directly over the network 101 between the near-end and far-end user terminals 102, 106, i.e. without being relayed by the server 104. In the latter case the server 104 may nonetheless provide some supporting functions such as: to provide address look up (or this could be done in a P2P fashion); to issue digital authentication certificates by which users 105, 107 may prove their identities to one another; to store respective contact lists of the users 105, 107, being a list of other users the respective user has agreed to accept as contacts for communicating with within the communication service; to store profile information of each user which is viewable by other users within the communication service; and/or to maintain presence information indicating to other users whether the respective user's availability to be communicated with within the communication service.

In embodiments, the communication client application (e.g. VoIP application) 112 may be an application other than the native dialler of the operating system 110, i.e. the default dialler user for telephone calls, which is either one of the other applications 114 or an integrated function of the operating system 110 itself

Whatever form the client application 112, the call and the communication service take, the communication client application 112 is configured so as when run on the near-end user terminal 102 to present the user with a graphical user interface of the client, enabling the user to control various call-related functions, such as to answer an incoming request to establish the call from the client on the far-end user terminal 106 (if it is an incoming call, i.e. initiated by the far-end user), or to send a call establishment request to the client on the far-end user terminal 106 requesting to establish the call (if it is an outgoing call, i.e. initiated by the near-end user). Other examples of call related functions which the user may control through the GUI of the client 112 include muting the transmitted audio of the call (so the near-end user can't be heard by the far-end user), turning the volume of the received audio up or down, or selecting the far-end user 107 from a contact list (to establish the call if it is an outgoing call), or selecting to view profile information of the far-end user 107.

However, when using the GUI of the communication client application 112 on the user terminal 102, the user 103 typically has to follow several steps in order to perform simple tasks. For example, to join a scheduled meeting, they must first find and navigate to an app, launch the app or bring it to the foreground, then navigate to the screen, locate the next meeting and then select the join meeting item. This can be further complicated if the user's mobile device is in a locked state. This inconveniences the user and gets in the way of them using apps like VoIP applications efficiently and frequently.

This issue can be circumvented to some extent using on-screen push notifications, which alert the user 103 to get his or her attention and permit him or her to enter an application within a particular context by selecting the notification on screen. However, the user still has to manually handle the user terminal 102, which is not necessarily desirable, e.g. for a complete hands free experience. For instance, the user still has to approach the user terminal 102 and select a small and potentially fiddly on-screen control to accept the notification.

Another possibility is to connect a hardware accessory (a peripheral) to the user terminal 102. Conventionally each of the controls on the peripheral maps directly to a specific function within the application on the user terminal 103. For example, a play button on a Bluetooth speaker may cause music or other audio to start playing on a connected mobile terminal, or a mute. In some cases, the connection of the peripheral to the user terminal 102 may also cause a particular application (e.g. a mobile app) to be launched upon connection (wired or wireless), or else the application may be launched upon activation of an on-screen control on the user terminal 102. However, to have multiple different functions, the user still has to manually select from amongst multiple different controls, whether on the peripheral or on-screen or a combination of such controls.

To address such considerations or similar, the following discloses a peripheral 108 that connects to the user terminal 103 (by either a wireless or wired connection) and that can be activated either by a simple gesture such as touching, clicking or waving, or by voice or audio command. When the control is activated, it causes a signal or message to be sent to a particular application 112 running on the user terminal 102 which then responds by executing a contextual application function or series of functions.

Thus, rather than having an accessory that simply causes an application to launch or one that has controls that map directly in a one-to-one manner to functions within an application, there is provided an accessory control that maps indirectly to functionality within one or more apps that: i) may behave differently in different application states, screens or contexts within the same app; ii) may behave differently in different applications running on the same connected terminal 102 and iii) where the control may be emplaced on a variety of accessory types and connected via wired or wireless methods.

For example, if a user is not currently using the communications application 112, then activating the accessory control may cause the client 112 to launch or come to the foreground; but if the user is already in the application 112, activating the same control may cause the client application 112 to join a meeting (e.g. by VoIP); whereas if the user 103 is already in a meeting (e.g. VoIP meeting), activating the same control may cause the user to be muted within the meeting. This thus provides a smart control accessory that serves as a smart application shortcut.

Note: the present disclosure may be described in relation to VoIP calls, but in further embodiments the peripheral device 108 can work with both VoIP and cellular calls.

An example implementation of the peripheral device 108 is illustrated in FIG. 1. As shown, the user terminal 102 comprises a peripheral interface 118, and the peripheral device 108 comprises a user terminal interface 134 for connecting the peripheral 108 to the peripheral interface 118 of the user terminal, thus enabling the peripheral device 108 to control the communication client application 112 running on the user terminal 102. This connection could be any suitable wired or wireless means. For instance, the peripheral interface 118 may comprise a physical port comprising a mechanical connector for forming a wired connection with the user terminal interface 134 on the peripheral device 108 (the user terminal interface 134 on the peripheral 108 comprising the complimentary mechanical connector). E.g. the peripheral interface 118 may comprise a USB port, mini USB port micro USB port, and the user terminal interface 134 may comprise the corresponding USB plug. As another example, the connection may be by any of a variety of wireless means. For instance, the peripheral interface 118 and corresponding user terminal interface 134 may comprise a pair of wireless interfaces arranged to connect together via a local RF technology such as Wi-Fi, Bluetooth, ZigBee or Thread. Note also that in the case where both the peripheral interface 118 and network interface 120 comprise a wireless interface, these may or may not comprise the same physical interface. For example, these may comprise the same physical wireless interface using the same wireless access technology (e.g. Wi-Fi) and simply comprise different logic (e.g. software) for interfacing with the peripheral 108 and network 101 respectively. Alternatively, the peripheral interface 118 and network interface 120 may comprise different physical interfaces arranged to use different wireless access technologies, e.g. the peripheral interface 118 may be a Bluetooth interface whilst the network interface 120 may be a Wi-Fi interface.

The peripheral device 108 comprises control logic in the form of an embedded companion application running on an embedded operating system 130 on the peripheral, to act as a companion to the communication client application 112. The embedded operating system 130 and companion application 132 are stored on a storage means of the peripheral device 108 and arranged to be run (either executed or interpreted) on a processor of the user peripheral device 108, and to thereby perform the various operations attributed to them herein. The storage on which the embedded operating system 130 and companion application 138 are stored may comprise any one or more storage media implemented in one or more memory units. E.g. the storage means may comprise an electronic storage medium such as an EEPROM (or “flash” memory) and/or a magnetic storage medium such as a hard disk. Also, not again that the term “processor” as used herein does not exclude that the processor may comprise multiple processing units.

As an alternative (or in addition) to the embedded companion application 132, the control logic may be implemented (or partially so) in the form of dedicated hardware circuitry, or configurable or reconfigurable hardware circuitry such as a PGA (programmable gate array) or FPGA (field programmable gate array).

Either way, whether implemented in software, hardware circuitry or a combination of the two, the peripheral 108 may be described as a “hardware accessory” in that it is a simple, low-level peripheral device that cannot be used as a standalone user terminal without being connected as a peripheral to a user terminal 102. For example, in embodiments the operating system on the peripheral 108 does not comprise a user operating system designed to provide a graphical user interface to the user 103, but instead comprises an embedded operating system that does not comprise a presentation layer. Furthermore, preferably the peripheral device 108 does not comprise any display screen.

The peripheral device 108 does comprise at least one actuator 136, arranged to be simply and accessibly actuated by the near-end user 103. In embodiments the actuator 136 takes the form of a button arranged to be actuated by being pressed or touched by the user 103. Note that the term “button” does not necessarily limit to a mechanical mechanism with a moving or parts (though that is certainly one possibility for the actuator). In embodiments the button may comprise a mechanical button such as a push button, slide switch, rotational switch or toggle switch. Alternatively, the button may take the form of a touch sensor such as a capacitive touch sensor, which is actuated when it senses the touch of user's finger against an exterior surface of the touch sensor. In other alternative embodiments, the actuator may not be button, but rather a motion sensor comprising one or more motion sensor elements (e.g. one or more accelerometers, motion sensors and/or tilt switches) arranged to be actuated when it/they sense the peripheral device 108 being moved by the user 103, or when a particular predefined motion is sensed. As yet another alternative, the actuator 136 comprises a microphone and voice recognition algorithm arranged to be actuated in response to detecting a predetermined voice command from the user, or more generally an audio recognition algorithm arranged to detect a predetermined audio command (e.g. the user clapping his or her hands, clicking his or her fingers, or whistling).

Preferably the peripheral device comprises very few buttons, e.g. no more than three buttons. In embodiments the actuator 136 is the only user-operable button on the whole peripheral 108, or in embodiments that use motion or audio actuation, then the peripheral 108 could even comprise no buttons.

Whatever form the actuator takes, the control logic (e.g. embedded application) 132 on the peripheral 108 is configured to control a function of the communication client application (e.g. VoIP application) 122 in response to the actuation of the actuator 136 by the user 136 (e.g. in response to the pressing or touching of the button, the detection of motion or the predetermined motion, or the detection of the predetermined voice or other audio command). This control is conducted via the above-described connection between the peripheral 108 and user terminal 102 formed via the peripheral interface 118 on the user terminal 102 and the user terminal interface 134 on the peripheral device 108.

Furthermore, the control logic (e.g. embedded application) 132 on the peripheral 108 is configured such that the function which the actuation performs is dependent on a current status of the packet-based call conducted through the communication client application 112—i.e. the current context in which the actuator 136 is actuated. That is, if the actuator 136 is actuated by the near-end user 103 when the call has a first status, then the actuation of the actuator 136 causes the communication client application (e.g. VoIP client) 112 to perform a first function in relation to the call; but if the user performs an identical instance of the same actuation of the actuator 136 (same button press or touch, same motion, or same voice or audio command) at another time when the call has a second, different status, then that instance of the same actuation causes the communication client application 112 to perform a different function to be performed in relation to the call.

For instance, if the call is currently an incoming, unanswered call from corresponding client on the far-end user terminal 106 (i.e. the call is currently a pending call establishment request) then the function of the actuator 136 may be to answer the call. But if the call is answered and now ongoing (i.e. audio and optionally video media of the call is now being exchanged between the client 112 on the near-end terminal 102 and the corresponding client on the far-end terminal 106, and being played out at the relevant ends) then the actuator 136 may take on a different function. E.g. this second function may be to mute the transmitted audio of the call, i.e. the near-end user's audio is not sent to the far-end terminal 106. Alternatively, or additionally, if there is currently no incoming or ongoing call, the actuator 136 may take on another function such as retrieving and playing out the near-end user's voicemail.

In another example, the function of the actuator 136 may depend on whether there is currently a calendar event scheduled containing an invite to an online meeting via packet-based voice or video call (and/or depending on whether the calendar event scheduled to start within a predetermined time window from the present time). In embodiments, the communication client application 112 either has an in-built calendar function or is configured to access a calendar function of another application 114 running on the near-end user terminal 102 (e.g. the calendar function of an email application, or a dedicated calendar application). As another possibility the communication client 112 may access via the network 101 a calendar function hosted on a server. Wherever implemented, the calendar provides the ability for users and/or applications to schedule calendar events each having a certain specified start time and duration (or equivalently a specified start time and end time). Furthermore, in some cases a calendar event may take the form of a meeting invite containing a link to an online call to be conducted via the network 101 using the communication service (e.g. VoIP service), e.g. a multiparty conference call comprising more than two participants.

In embodiments, the control logic 132 is configured to detect whether there is currently a meeting invite scheduled in the calendar function (i.e. does the present time fall within the), and if so, to invoke the link in the meeting invite in response to actuation of the actuator 136 by the user, to thereby join the user into the meeting via packet-based voice or video call over the network 101. In variant of this, the actuator takes on said function of joining the user into the meeting on condition that the present time falls within a time window consisting of the duration of the meeting and a predetermined time window prior to the meeting. E.g. if there is a meeting scheduled to begin within the next five minutes, actuating the actuator 136 will join the meeting.

If on the other hand there is no meeting currently scheduled according to the calendar function (or no meeting within the next T minutes), then the actuator 136 takes on a different function, e.g. to listen to voicemail. And/or, if the user is now joined into the meeting, the actuator may have another functions such as muting the call.

In some embodiments the peripheral 108 may additionally be configured to provide the function of a speaker phone, comprising at least one integrated speaker 138 and/or at least one integrated microphone 140. Thus the peripheral may be configured such that, when connected to the user terminal 102, then one or both of: (a) the received audio of the call from the far-end user 107 can be played out through the speaker 138 of the peripheral 108 instead of the speaker 126 of the user terminal 102, and/or the audio of the call captured from the near-end user 103 to be transmitted to be played out to the far-end user 107 is a captured through the microphone 140 on the peripheral 108 instead of the microphone 128 of the user terminal 102.

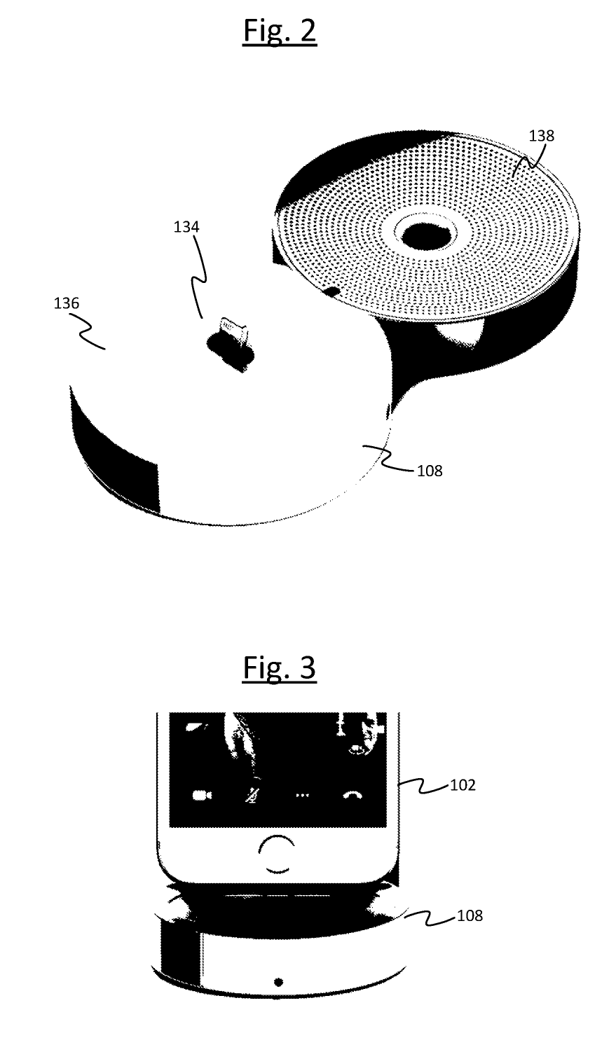

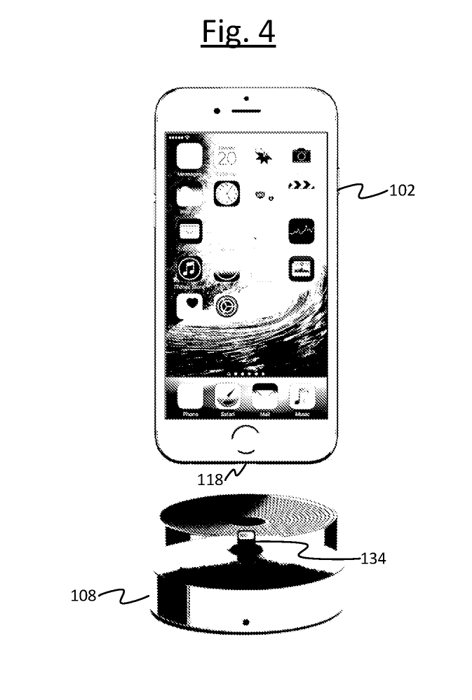

As will now be exemplified with reference to FIGS. 2 to 10, the peripheral device 108 may take any of a variety of different forms. Note that the particular aesthetic design of the user terminal 102 and its GUI shown in FIGS. 3, 4, 5, 7 and 8 is purely an example for illustrative purposes and does not form part of any subject matter to be claimed herein.

In embodiments the user terminal may take the form of a mobile user terminal such as a smartphone, tablet or laptop, and the peripheral device 108 may take the form of a docking station into which the mobile terminal 102 can be docked in order to form said connection between the peripheral interface 118 of the mobile terminal 102 and the user terminal interface 134 of the peripheral 108. The docking station may also be configured to charge a battery of the mobile terminal 102 when so docked.

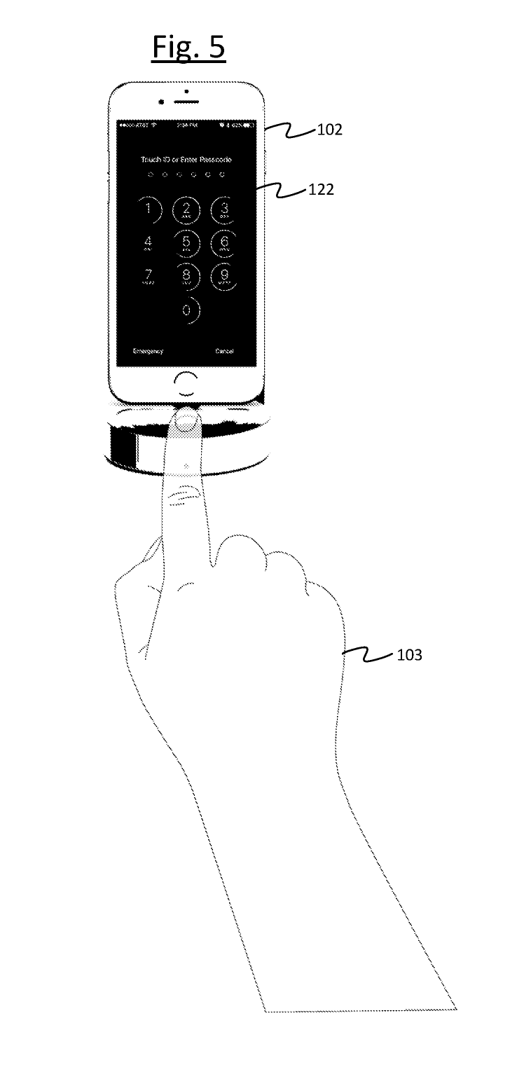

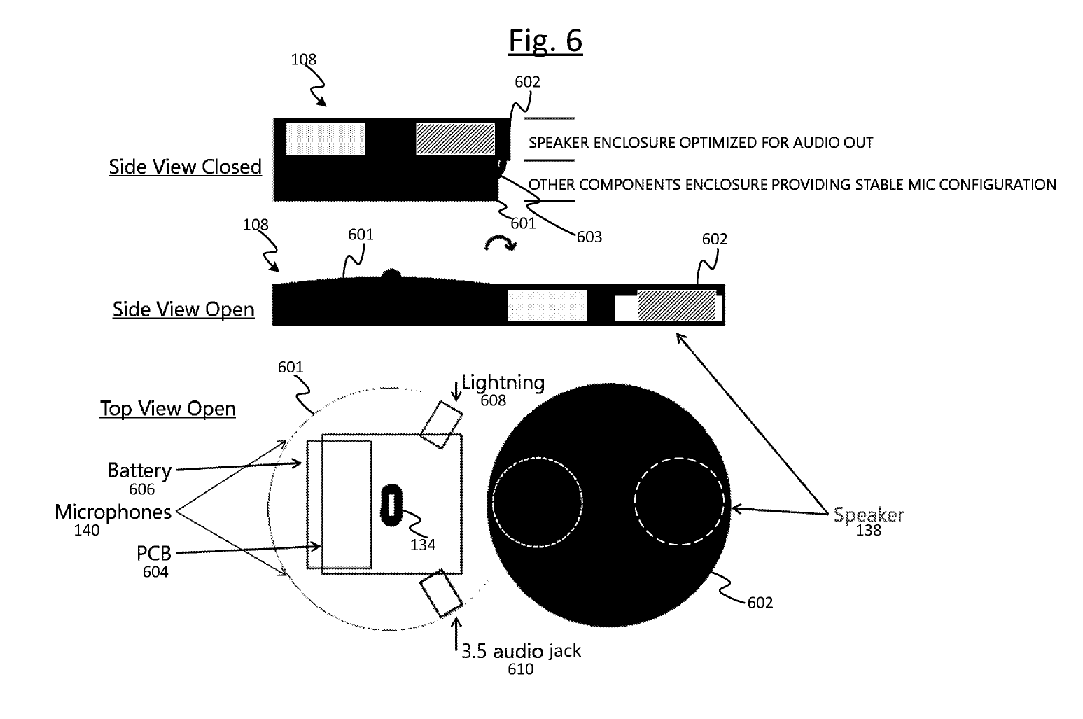

An example of this is illustrated in FIGS. 2 to 6. In this example the docking station 108 is also arranged to act as a speaker phone (see above) when the mobile terminal 102 is docked with the docking station 108. FIGS. 2 to 6 show different views of the same example design. As illustrated in FIGS. 2 and 5, the docking station 108 may comprise a base segment 601 and a cover segment 601, movably connected via a movable joining element 603 such as a hinge so that the cover segment 603 can be opened to reveal the port 134 for connecting to the mobile terminal 108 (e.g. this may comprise a mechanical port such as a USB port, mini USB port or micro USB port). E.g. the joining element 303 may be arranged such that the cover section 602 slides or pivots laterally away from the base, whereas FIG. 6 seems to show the cover section hinges upwards from the base. Thus when the cover 602 is opened, the mobile terminal 102 can be docked with the docking station in order to provide the various functionality described herein.

In such embodiments, the actuator 136 preferably takes the form of a single button on the top surface of the base segment 601, e.g. a button ion the form of a touch sensor element or possibly a mechanical push button. In embodiments the button is a touch sensor and appears outwardly to the user 103 (i.e. aesthetically) to be continuous with the rest of the base segment 601. Preferably this is the only user input control on the exterior of the docking station 108, or at least other than on its underside which is not visible to the user 103 when placed in the intended orientation on a supporting surface such as a table.

In embodiments the speaker (or speakers) 138 may be incorporated in the cover segment 602 while the microphone (or microphones) 140 may be incorporated in the base segment 601.

In embodiments the docking station 108 may optionally comprise one or more further components, for example one or more lights 608 (e.g. LEDs) which are arranged to provide an indication to the near-end user 103 of a certain predefined state of the communication client application 112 (e.g. VoIP application) or a certain predefined event occurring within the communication service (e.g. VoIP service). As another example the docking station may comprise an additional audio input such as a jack socket, e.g. a 3.5 mm jack socket, allowing the user 103 to plug an audio device other than the mobile terminal 102 (e.g. a dedicated music player) into the docking station and have audio played out from the audio device through the speaker(s) 138 of the docking station 108. Further, in embodiments, the control logic 132 (e.g. the embedded memory storing the embedded operating system 130 and companion application 132) may be mounted on a printed circuit board incorporated inside the housing of the base segment 601.

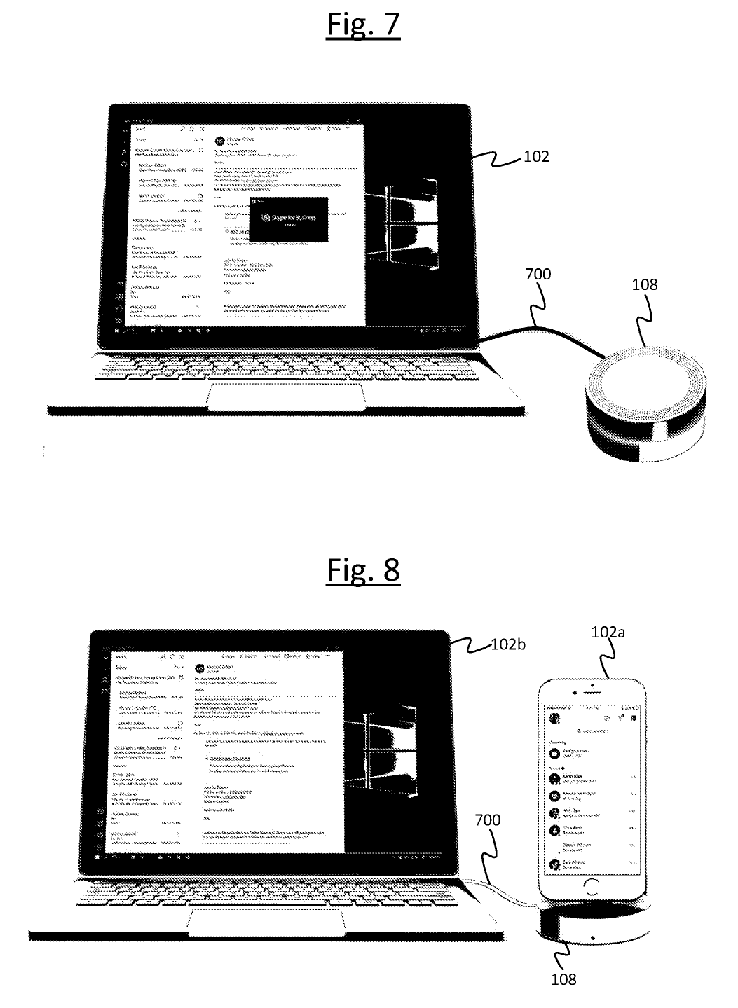

Referring to FIG. 7, in some embodiments the docking station 108 may further be configured so that it can be connected to another type of user terminal 102 such as a laptop or desktop computer via a cable connection 700 or similarly by a wireless connection such as a Wi-Fi or Bluetooth connection. Or the peripheral 108 may not take the form of a docking station but rather a unit for connecting to a laptop or desktop computer or even a smartphone or tablet via such a wireless or cable connection 700. Either way, the peripheral 108 may be configured such that it can provide any of the above-described functionality via this connection 700, with the laptop, desktop or other device as the user terminal 102. In some embodiments, as shown in FIG. 8, the peripheral 108 may take the form of a docking station 108 that can simultaneously both connect to a larger user terminal such as a laptop or desktop via a wireless or wired connection 700 and also receive a smaller docked mobile user terminal such as a smartphone or tablet into its docking port. In this case the call functionality may be provided via a combination of a first near-side instance of the client application 112 running on the smaller user terminal and a second instance of the client application 112 running on the larger user terminal. In embodiments the control logic 132 on the peripheral can control one or both of them in order to control the relevant function of the call.

Note that the particular docking station of FIGS. 2 to 6 has been described only by way example. As mentioned previously, a docking station can be any station into which the mobile terminal 102 can be docked in order to form the connection between the station 108 and the mobile terminal 102. The means by which the mobile terminal docks into the station could take any of a variety of forms for supporting the mobile terminal.

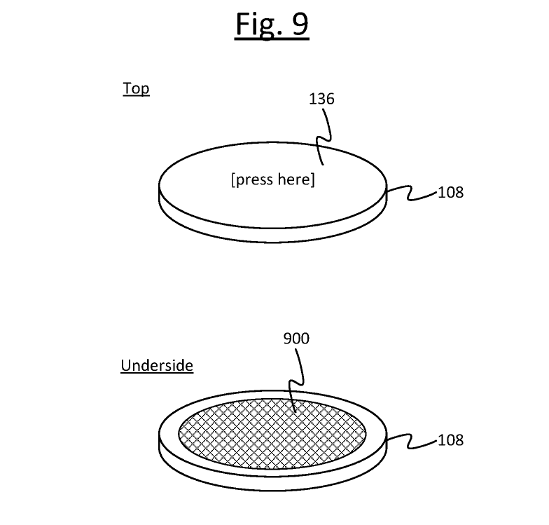

An alternative form for the peripheral device 108 is illustrated in FIG. 9. Here the peripheral 108 takes the form of a dedicated, stand-along button unit, e.g. about the size of a large coin or not much larger. In this embodiment the button unit 108 preferably comprises only a single button (i.e. the actuator 136) and no other user input control, at least not on its exterior surface. The actuator 136 takes the form of a button on the upper surface of the button unit, e.g. a touch sensor element or a mechanical push button. On the underside of the button unit 108 is a magnetic or adhesive layer 900 for affixing the button unit to another, external surface, e.g. a surface of the user terminal 102 on which the client application 112 to be controlled is installed. In such embodiments the user terminal interface 134 comprises a wireless interface such as a Bluetooth or Wi-Fi interface so the button unit 108 can communicate with and control the client application 112 for any of the above-described purposes.

In some particular embodiments, the button unit 108 may take the form of a fridge magnet, the layer 900 being a magnetic layer (N.B. the “layer” need not be of any specific width, depth or other dimensions as long the magnetism is sufficient to support the weight of the button unit 108). In this embodiment the user terminal 102 may be the fridge itself if it is a smart fridge with embedded communications functionality. Alternatively, the user terminal 102 may be another device such as a smart phone, tablet, laptop or desktop within range of the fridge magnet's wireless interface 134.

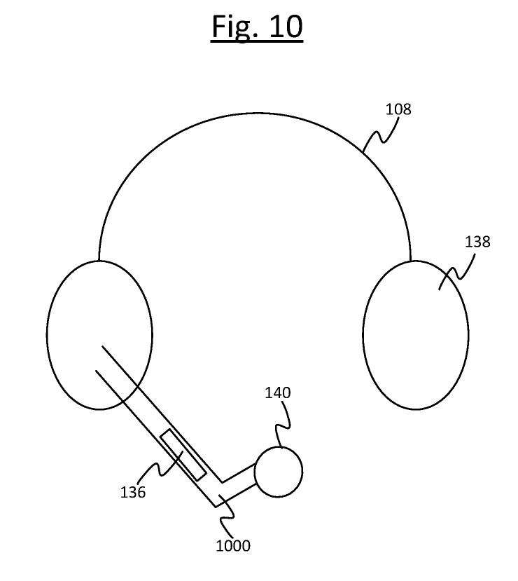

An alternative form for the peripheral device 108 is illustrated in FIG. 10. Here the peripheral 108 takes the form of a headset, e.g. a Bluetooth headset. The headset comprises one or a pair earphones which provide the speakers 138 of the peripheral 108, and a microphone arm 1000 on the end of which the microphone 140 of the peripheral 108 is mounted, the microphone arm 100 being arranged to hold the microphone 140 near the user's mouth. In this example the actuator 136 may take the form of a button such as a touch sensor element or mechanical push button placed on the exterior of the headset, e.g. on the microphone arm 100 or on the outer casing of one of the headphones 138. In another somewhat similar embodiment, the peripheral device may take the form of an earpiece such as a Bluetooth earpiece.

Note that as shown in FIG. 5, in embodiments the system is arranged such that the near-end user 103 can answer an incoming call from the far-end user even when it the near-end user terminal 102 is in a locked mode, e.g. even when the touchscreen 122 of the near-end user terminal 102 is locked. As will be familiar to a person skilled in the art, the operating system 110 on the user terminal 102 typically has an unlocked mode and a locked mode, wherein in the locked mode the operating system 110 will only allow the user terminal 102 to react to user inputs, e.g. via the touch screen, in specific circumstances more limited than in the unlocked mode, but not otherwise. These circumstances may include that the user 103 has entered a secret code such as a PIN or secret pattern required to return the operating system 110 back to the unlocked mode, or that an application 112, 114 on the user terminal 102 has received a push notification from an external entity (e.g. a server or another user terminal) over the network 101. The operating system 110 may be configured to automatically fall into the locked mode after a certain predetermined time period has elapsed since a user input was last received by the user terminal 102, and/or may be configured such that the user 103 can manually place it into the locked mode.

Either way, in embodiments a mechanism is put in place whereby the near-end user 103 can answer an incoming call from the far-end user 107 by actuating the actuator 136 on the peripheral device 108 despite the operating system 110 on the user terminal being in the locked state. To enable this, the operating system 110 is configured to still allow a peripheral to communicate with an application 112, 114 when the operating system 110 is in the locked state. Further, the operating system 110 is configured so as when in the locked state to still to be able to receive push notifications from a push notification service over the network 101 (e.g. the Internet), to notify a peripheral of the incoming push notification, and to allow the peripheral to wake up a certain degree of functionality of an application 112, 114 in response (e.g. to use the speaker 126 but not the screen 122).

When the communication client application (e.g. VoIP application) 112 is first installed on the user terminal 102 it registers with a push notification service provided by the server 104 of the communication service provider. Subsequently, when the far-end user 107 attempts to make a call to the near-end user 103 using the communication service (e.g. VoIP service) provided by that communication service provider, but when the operating system 110 on the near-end user's terminal 102 is in the locked state, then the push notification service on the server 104 sends a push notification to the near-end user terminal 102 via the network (e.g. Internet) 101 notifying the operating system 110 on the near-end terminal 102 that there is an incoming communication destined for the communication client application (e.g. VoIP application) 112. In response the operating system 110 notifies the control logic (e.g. embedded application) 132 of this via the interface 118, 134 between the user terminal 102 and peripheral 108. In response the peripheral 108 may output some indication of the incoming communication to the near-end user 103 (e.g. by flashing the light 608, and/or emitting a ringing sound from the speaker(s) 138 of the peripheral 108). Alternatively, or additionally the operating system 110 may output some notification via the speaker(s) 126 and/or screen 122 of the user terminal 102. If the user 103 then actuates the actuator 136 on the peripheral 108 (e.g. presses the touch sensor or push button on the base of the docking station) then the control logic 132 on the peripheral sends a signal back to the operating system 110 via the interface 134 between the peripheral 108 and the user terminal 102. The operating system 110 then allows the call to be answered and conducted using either the speaker 126 on the user terminal 102 or the speaker 138 on the peripheral 108, and either the microphone 128 on the user terminal 102 or the microphone 140 on the peripheral 108, but in embodiments while still keeping the screen 122 of the user terminal 102 locked.

Note: while FIG. 5 illustrates the case of a locked screen 122 when the peripheral 108 is a docking station, the above mechanism can apply to other forms of peripheral as well, e.g. those of FIGS. 7, 9 or 10 or others (e.g. an earpiece).

In further embodiments, the control of the communication client application 112 by the control logic (e.g. embedded application) 132 on the peripheral 108 is performed by the control logic 132 on the peripheral invoking a URI linking to the required function within the communication client application 112 on the user terminal 102, e.g. a URI in the form of a mobile deep link.

Deep linking is the process by which hyperlinks extend from one mobile or desktop app into specific pages or screens of another for transferring information, context, and commands from one app to another that is retained across intermediate steps. While some devices can cause an application or service on another device to be launched, they generally do not deep link or provide more complex behaviour. Embodiments disclosed herein provide a method by which a control or gesture on a peripheral or accessory device 108 causes a deep link to be activated on another device 102 such as a mobile phone or a laptop. The deep link may refer to a specific page, screen, or service and provide optional contextual information about the state of the triggering device 108 or other information that may originate on the triggering device 108 or elsewhere.

A uniform resource indicator (URI) is a string of characters used to identify a resource such as an application. Thus, amongst other uses, URIs enable a first application to initiate an action by a second application. To do this, the first application invokes the URI via the operating system on which the first application is running, i.e. by indicating the URI in a request to the operating system so that in response the operating system calls upon the second application. The second application may be running on the same instance of the operating system on the same user terminal as the first application, or alternatively may be run on a remote terminal in which case the URI causes it to be contacted via a suitable network such as the Internet.

A URI comprises a left-most portion called the “scheme” which identifies the resource, in this case the application. Optionally the URI also comprises one or more further portions which qualify the action to be taken in response to the URI. An example is the “mailto” URI scheme which when invoked by, say, a web browser, calls upon an email client in order to open a new email. For instance, invoking the following URI would open a new email to a user Dave Example whose email address is dave@example.com.

mailto:dave@example.com

A URI can be associated with a particular application. When a new application is first installed on a given user terminal, it can register its URI scheme with a list of custom URI schemes recognized by the operating system on that terminal. Another application can then initiate an action by that application by invoking a URI comprising the registered URI scheme. For example, say a company called Acme runs an internet-based communication service and provides a corresponding communication client application for conducting communications such as VoIP calls and/or instance messaging (IM) via said service. Say also that this company is allocated the URI scheme “acme”. When the communication client is installed it registers the URI acme with the operating system's list of custom URI schemes. Another application can then launch the communication client by invoking the following URI.

acme:

Or if Dave's username within the communication system is dave_example, the other application can then initiate a default action in relation to Dave, e.g. a voice over IP (VoIP) call, by invoking the following URI.

acme:dave_example

A mobile deep link is a URI that links to a specific function within an application, rather than simply launching an application generally. Examples would be as follows.

acme:dave_example?chat initiates an IM chat session with Dave

acme:dave_example?call&video=true initiates a video call with Dave

acme:dave_example?profile views Dave's profile

The term “mobile deep links” refers to the use of such links in the context of one or both of the applications being a mobile applications run on a mobile terminal (whether the same mobile terminal or different ones), but a similar mechanism can also be used by applications run on one or more static terminals, or to implement interactions between mobile and static terminals.

A uniform resource locator (URL) is a URI that, as well as identifying a resource, specifies a particular means of acting in relation to it. An example of a URL scheme is http, which specifies that communications with the resource resulting from invocation of the URL shall be conducted according to Hypertext Transfer Protocol (HTTP). Another example of a URL scheme is https, which specifies that communications with the resource resulting from invocation of the URL shall be conducted according to the HTTPS (HTTP Secure) protocol. In the latter case, the application being linked to is authenticated before communications can proceed, and when they do, the communicated data is encrypted according to a cryptographic standard such as TLS (Transport Layer Security) or SSL (Secure Socket Layer).

If a first application links to a second application via a URL in the form of an HTTP or HTTPS link, an advantage of this is that it provides a web fall-back in case the second application is not available locally on the same terminal as the first application. When the URL is invoked the operating system checks whether it has the respective URL scheme in its register of custom URI schemes. If so, it calls upon the local instance of the application installed on the same terminal as the first application to perform the desired action. If not however, it either downloads an instance of the second application from the web or calls upon a web-hosted version of the second application in order to perform the action in question (optionally after prompting the user with an option to do one of these). An example would be:

https://call.acme.com/dave_example

The first application invokes this URL in order to initiate a voice call (e.g. VoIP) with Dave Example via the Acme communication service. In response the operating system checks whether the there is a locally installed instance of the Acme client. If so, the operating system launches the local acme client (or switches to it if already running in a background state) and passes it at least an indication of the requested action (in this case a call) and the target of the action (the username “dave_example”). In turn the local instance of the Acme client sends a call establishment request to the remote instance of the Acme client running on the Dave's user terminal and, if Dave accepts, proceeds to conduct the call.

If, however the operating system finds, when the URL is invoked, that there is no local instance of the Acme client installed locally on the same user terminal as the first application and the operating system, then the operating system instead uses the URL to contact the Acme server to either download an instance of the Acme client (and then proceed as outlined above), or to send the call establishment request and conduct the call via a web-hosted version of the Acme client. The user may be prompted before doing this.

According to embodiments disclosed herein, when the user actuates the actuator 136 on the peripheral device 108, this causes the control logic 132 (e.g. embedded application) on the peripheral to invoke a URI linking to a specific function within the communication client application 112 on the user terminal 102, e.g. to answer an incoming call or to mute the near-end user 103. In embodiments the URI may comprise a URL so as to provide a web fall-back. That is, if an instance of the communication client application (e.g. VoIP application) 112 is not installed on the user terminal when the actuator 136 is actuated and the URL invoked, then this causes an instance of the communication client application 112 to be downloaded to and installed on the user terminal 102 from the communication service provider's server 104 via the network (e.g. Internet) 101. The call can then proceed using the newly installed client 112.

In alternative embodiments, the web fall-back is not to install a client 112, but instead for the user terminal 102 to use a web-hosted instance of the client.

It will be appreciated that the above embodiments have been described only by way of example. Other variants may become apparent to a person skilled in the art once given the disclosure herein. The scope of the present disclosure is not limited by the described embodiments but only by the accompanying claims.

Implementations discussed herein include:

Example 1: A peripheral device for use with a user terminal, the peripheral device comprising: a non-graphical actuator operable to be actuated by a user; an interface for connecting to the user terminal; and control logic for interfacing with the user terminal via said interface, in order to control a communication client application running on the user terminal, and to thereby control a voice or video call that is conducted over a packet-based network from the user terminal using the communication client application; wherein the control logic is configured such that said control of the call comprises performing a function in relation to the call in response to actuation of said hardware actuator by the user, and wherein the control logic is further configured such that the function of said actuation of the actuator is dependent on a current status of the call.

Example 2: The peripheral device of example 1, wherein the peripheral device does not comprise any display screen.

Example 3: The peripheral device of example 1, wherein the peripheral device comprises a speaker and/or microphone, arranged to enable received audio of the call to be played out to the user via said speaker and/or the transmitted audio of the call to be captured from the user via said microphone.

Example 4: The peripheral device of example 1, wherein the control logic is configured to enable the user to answer or join the call by said actuation of said hardware actuator, without having to navigate through any graphical user interface on the user terminal.

Example 5: The peripheral device of example 4, wherein the control logic is configured to download the communication client application to the user terminal if not installed upon the actuation of said actuator to answer the call.

Example 6: The peripheral device of example 1, wherein the status of the call transitions from incoming before the call is answered by said user to ongoing after the call is answered by the user, and wherein the control logic is configured such that the function of said actuation of the actuator is to answer call when the status is incoming, but the function of said actuation of the actuator takes on at least one second, different function when the status of the call is ongoing.

Example 7: The peripheral device of example 1, wherein: the call is scheduled to form part of an online meeting scheduled via a meeting invite, the status of the call being unjoined before the user has joined the meeting and joined after the user has joined the meeting; and the control logic is configured such that, at a present time, the function of said actuation of the actuator is to join the meeting via said call on condition that the call is unjoined and the present time is within a predetermined time window relative to the scheduled meeting, but otherwise the function of said actuation of the actuator takes on at least one second, different function.

Example 8: The peripheral device of example 6, wherein the second function is to mute the call.

Example 9: The peripheral device of example 1, wherein the control logic is configured such that the function performed by the actuation of the actuator is never to hang up the call.

Example 10: The peripheral device of example 1, wherein said actuator takes the form of a mechanical button, or a touch sensor other than a touchscreen, or a motion sensor.

Example 11: The peripheral device of example 1, wherein the control logic comprises embedded software and an embedded processor arranged to run the embedded software, and wherein the software is arranged to run on an embedded operating system having no presentation layer.

Example 12: The peripheral device of example 1, wherein said hardware actuator is a single hardware actuator being the only user input means included on the peripheral device.

Example 13: The peripheral device of example 1, wherein the peripheral device takes the form of: a docking station, said interface being arranged to form said connection with the user terminal when the user terminal when docked with the docking station; or a headset or earpiece.

Example 14: The peripheral device of example 12, wherein the peripheral device takes the form of a stand-alone button unit with no user output means and no other user input means than said single hardware actuator.

Example 15: The peripheral device of example 14, further comprises an adhesive or magnetic layer on an exterior surface of the button unit for affixing to the user terminal.

Example 16: The peripheral device of example 1, wherein the control logic is configured to control said function by invoking a URI that links to the function within the communication client application run on or accessed through the user terminal.

Example 17: A system comprising: a non-graphical actuator operable to be actuated by a user; an interface for connecting to a user terminal; control logic for interfacing with the user terminal via said interface, in order to control a communication client application running on the user terminal, and to thereby control a voice or video call that is conducted over a packet-based network from the user terminal using the communication client application; wherein the control logic is configured such that said control of the call comprises performing a function in relation to the call in response to actuation of said hardware actuator by the user, and wherein the control logic is further configured such that the function of said actuation of the actuator is dependent on a current status of the call; and wherein the user terminal has a display screen and a user operating system having a presentation layer for rendering a graphical user interface of the communication client application on said display screen.

Example 18: The system of example 17, wherein the communication client application is not the native dialler of the operating system on the user terminal.

Example 19: The system of example 17, wherein the user terminal takes the form of a desktop computer, laptop computer, tablet or smart phone.

Example 20: A method comprising: connecting a peripheral device to a user terminal, in order to enable the peripheral device to control a communication client application running on the user terminal, and to thereby control a voice or video call conducted from the user terminal using the client application; the user actuating a non-graphical actuator on the peripheral device; and in response to said actuation of the hardware actuator by the user, the peripheral device performing a function in relation to the call via said connection, wherein the function of said actuation of the actuator is made dependent on a current status of the call.

1. A peripheral device for use with a user terminal, the peripheral device comprising:
a non-graphical actuator operable to be actuated by a user;
an interface for connecting to the user terminal; and
control logic for interfacing with the user terminal via said interface, in order to control a communication client application running on the user terminal, and to thereby control a voice or video call that is conducted over a packet-based network from the user terminal using the communication client application;
wherein the control logic is configured such that said control of the call comprises performing a function in relation to the call in response to actuation of said hardware actuator by the user, and wherein the control logic is further configured such that the function of said actuation of the actuator is dependent on a current status of the call.

2. The peripheral device of claim 1, wherein the peripheral device does not comprise any display screen.

3. The peripheral device of claim 1, wherein the peripheral device comprises a speaker and/or microphone, arranged to enable received audio of the call to be played out to the user via said speaker and/or the transmitted audio of the call to be captured from the user via said microphone.

4. The peripheral device of claim 1, wherein the control logic is configured to enable the user to answer or join the call by said actuation of said hardware actuator, without having to navigate through any graphical user interface on the user terminal.

5. The peripheral device of claim 4, wherein the control logic is configured to download the communication client application to the user terminal if not installed upon the actuation of said actuator to answer the call.

6. The peripheral device of claim 1, wherein the status of the call transitions from incoming before the call is answered by said user to ongoing after the call is answered by the user, and wherein the control logic is configured such that the function of said actuation of the actuator is to answer call when the status is incoming, but the function of said actuation of the actuator takes on at least one second, different function when the status of the call is ongoing.

7. The peripheral device of claim 1, wherein:
the call is scheduled to form part of an online meeting scheduled via a meeting invite, the status of the call being unjoined before the user has joined the meeting and joined after the user has joined the meeting; and
the control logic is configured such that, at a present time, the function of said actuation of the actuator is to join the meeting via said call on condition that the call is unjoined and the present time is within a predetermined time window relative to the scheduled meeting, but otherwise the function of said actuation of the actuator takes on at least one second, different function.

8. The peripheral device of claim 6, wherein the second function is to mute the call.

9. The peripheral device of claim 1, wherein the control logic is configured such that the function performed by the actuation of the actuator is never to hang up the call.

10. The peripheral device of claim 1, wherein said actuator takes the form of a mechanical button, or a touch sensor other than a touchscreen, or a motion sensor.

11. The peripheral device of claim 1, wherein the control logic comprises embedded software and an embedded processor arranged to run the embedded software, and wherein the software is arranged to run on an embedded operating system having no presentation layer.

12. The peripheral device of claim 1, wherein said hardware actuator is a single hardware actuator being the only user input means included on the peripheral device.

13. The peripheral device of claim 1, wherein the peripheral device takes the form of:
a docking station, said interface being arranged to form said connection with the user terminal when the user terminal when docked with the docking station; or
a headset or earpiece.

14. The peripheral device of claim 12, wherein the peripheral device takes the form of a stand-alone button unit with no user output means and no other user input means than said single hardware actuator.

15. The peripheral device of claim 14, further comprises an adhesive or magnetic layer on an exterior surface of the button unit for affixing to the user terminal.

16. The peripheral device of claim 1, wherein the control logic is configured to control said function by invoking a URI that links to the function within the communication client application run on or accessed through the user terminal.

17. A system comprising:
a non-graphical actuator operable to be actuated by a user;
an interface for connecting to a user terminal;
control logic for interfacing with the user terminal via said interface, in order to control a communication client application running on the user terminal, and to thereby control a voice or video call that is conducted over a packet-based network from the user terminal using the communication client application;
wherein the control logic is configured such that said control of the call comprises performing a function in relation to the call in response to actuation of said hardware actuator by the user, and wherein the control logic is further configured such that the function of said actuation of the actuator is dependent on a current status of the call; and
wherein the user terminal has a display screen and a user operating system having a presentation layer for rendering a graphical user interface of the communication client application on said display screen.

18. The system of claim 17, wherein the communication client application is not the native dialler of the operating system on the user terminal.

19. The system of claim 17, wherein the user terminal takes the form of a desktop computer, laptop computer, tablet or smart phone.

20. A method comprising:
connecting a peripheral device to a user terminal, in order to enable the peripheral device to control a communication client application running on the user terminal, and to thereby control a voice or video call conducted from the user terminal using the client application;
the user actuating a non-graphical actuator on the peripheral device; and
in response to said actuation of the hardware actuator by the user, the peripheral device performing a function in relation to the call via said connection, wherein the function of said actuation of the actuator is made dependent on a current status of the call.
